(19) United States
(12) Patent Application Publication
(10) Pub. No.: US 2024/0417608 A1
(43) Pub. Date: Dec. 19, 2024

(54) ONE-COMPONENT MOISTURE CURING COMPOSITION

(71) Applicant: SIKA TECHNOLOGY AG, Baar (CH)

(72) Inventors: Klaas MENNECKE, Lottstetten (DE); Shohei MURAMATSU, Chigasaki (JP); Gene Frederick GAGABE, Yokohama (JP); Takuya KUNITOMO, Chigasaki (JP); Yuki HAYASHI, Fujisawa (JP); Hans HÄBERLE, Gailingen (DE)

(73) Assignee: SIKA TECHNOLOGY AG, Baar (CH)

(21) Appl. No.: 18/706,777

(22) PCT Filed: Jan. 5, 2023
(86) PCT No.: PCT/EP2023/050192

§ 371 Date: May 2, 2024

(30) Foreign Application Priority Data
Jan. 10, 2022 (EP) 22150798.1

(51) Int. Cl. C09J 175/08; C09J 5/00; C09J 11/06

(52) U.S. Cl. CPC C09J 175/08; C09J 5/00; C09J 11/06

(57) ABSTRACT

A one-component moisture curing composition including 100 weight parts of a polymer containing silane groups of the formula (I), 5 to 50 weight parts of at least one liquid epoxy resin, at least one polyketimine, 2 to 15 weight parts of at least one epoxy silane, 0 to 500 weight parts of fillers and 0 to 500 weight parts of plasticizers.

### TECHNICAL FIELD

Elastic one-component moisture curing compositions based on a combination of silane group-containing polymers and epoxy resins.

### STATE OF THE ART

Elastic sealants and adhesives for construction or industry applications are well known, for example as joint sealers or adhesive joints in vehicle construction. For some applications, the elastic material needs to have soft-elastic properties with a high elongation combined with a moderate hardness and e-modulus. Such materials allow elastic joints which can compensate some movements of the joined bodies without transferring high stress to the adhered surfaces. Soft-elastic sealants and/or adhesives are typically based on polyurethanes or on silane-functional polymers. Unfortunately, these materials show weaknesses in terms of adhesive properties and often need a laborious pretreatment to achieve reliable adhesive forces that are stable after water immersion and/or heat attack. For some applications soft-elastic sealants and/or adhesives need to have a high heat resistance, for example for joints on vehicle bodies which are going to be powder coated at 180° C., as well as for sealants for battery boxes of e-vehicles, which have to withstand temperatures of 80° C. or more. The known soft-elastic sealants and/or adhesives based on polyurethane polymers or silane-functional polymers are not able to fulfil this need.

US 2021/163667 describes soft-elastic compositions based on silane- and/or isocyanate-functional polymers. These compositions show weaknesses in terms of adhesive properties and heat resistance.

Adhesives based on a combination of silane-functional polymers and epoxy resins are known. Materials of high hardness and some elongation are achievable with such combinations. They are typically packed as two-component compositions in two separate containers and need a mixing step before or during the application. This is inconvenient and makes the process prone to mistakes in relation to mixing ratio, incomplete mixing or an exceeded waiting time between mixing the components and the application, which can lead to insufficient cure or bad adhesion properties. Such adhesives are described for example in US 9,856,374 or US 10,428,252. They typically contain high amounts of epoxy resin and show a high hardness with limited flexibility. Also known are one-component moisture curing compositions based on a combination of silane group-containing polymers and epoxy resins, for example from JP 2003-128755, JP 2003-128756 or US 2016/0122606. They describe ketimine-containing compositions which are stored and applied from a single container without the need of a mixing step. The known compositions are based on silane group-containing polymers, which are products from the hydrosilylation of polyetherglycol allylethers, so-called MS Polymers. These compositions enable adhesives or sealants with adhesion to mortar or concrete under dry conditions. However, the obtained adhesion after water immersion and the heat stability after curing of these compositions are insufficient.

### SUMMARY OF THE INVENTION

The task of this invention is to provide a one-component moisture curing composition with soft-elastic properties, a good resistance to heat and good adhesion properties, particularly to mortar or concrete, especially after water immersion and/or heat exposure.

Surprisingly, this task is achieved with the composition according to claim 1. The inventive composition contains a special silane-group containing polymer, a relatively small amount of epoxy resin, a high amount of epoxy silane, a polyketimine and possibly fillers and/or plasticizers. Surprisingly, the inventive composition shows a highly improved adhesion on mortar or concrete after water immersion, together with a surprisingly good adhesion on plastic substrates such as PVC. Further surprisingly, the cured composition shows an excellent heat stability, even up to 2 hours at 200° C., and long-term resistance up to 28 days at 90° C. or 24 hours at 180° C. This excellent heat stability is most surprising for soft-elastic materials. Materials with soft-elastic properties are based on a polymer network which is not highly crosslinked and prone to depolymerization upon heat exposure.

The inventive composition is particularly suitable for the use as sealant and/or adhesive, particularly in the construction or manufacturing industry or in vehicle construction, particularly for joint or cavity sealing, for example for high rise façades or ship decks, for the bonding of wall panels to façades or for module bonding, particularly for module bondings in vehicle construction, or for the sealing of battery boxes of e-vehicles.

Other aspects of the invention are described in other independent claims. Preferred aspects of the invention are described in dependent claims.

### DETAILED DESCRIPTION OF THE INVENTION

The subject of the invention is a one-component moisture curing composition comprising
100 weight parts of a polymer P1 containing silane groups of the formula (I),

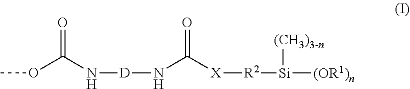

wherein
n is 2 or 3
R¹ is a linear or branched C₁ to C₅ alkyl group,
R² is a difunctional C₂ to C₁₂ hydrocarbon group or a difunctional C₃ to C₁₂ hydrocarbon group containing an amide or a carbamate group,
X is O or S or NR³, and R³ is hydrogen or a C₁ to C₁₀ hydrocarbon group or a C₃ to C₂₀ hydrocarbon group containing one or two ether or carboxylic ester groups or an alkoxysilane group, and
D is a divalent C₄ to C₁₅ hydrocarbon group,
5 to 50 weight parts of at least one liquid epoxy resin,
at least one polyketimine,
2 to 15 weight parts of at least one epoxy silane,
0 to 500 weight parts of fillers, and
0 to 500 weight parts of plasticizers.

In this document, the term “one-component moisture curing composition” refers to a composition which is stored in a single moisture-tight container, has shelf life stability and cures when exposed to moisture without the need for additional components.

In this document, the term “shelf life stability” refers to the ability of a substance or composition to be stored at room temperature in a suitable container under exclusion of moisture for a certain time interval, in particular several months, without undergoing significant changes in application or end-use properties.

A dashed line in the formulae in the present document represents the bond between a substituent and the associated molecular moiety.

The term “silane group” refers to a silyl group which is bonded to an organic moiety and has hydrolyzable alkoxy groups on the silicon atom.

The term “silane” or “organosilane” refers to an organic compound containing at least one silane group.

The terms “epoxy silane”, “amino silane” or “hydroxy silane” refer to organosilanes having an epoxy, amine or hydroxy group on the organic moiety in addition to the silane group.

Substance names beginning with “poly”, such as polyamine, polyketimine or polyepoxide, refer to substances containing two or more of the functional groups in their name per molecule.

The term “amine hydrogen” refers to the hydrogen atoms of primary and secondary amine groups.

A “primary amine group” refers to an amine group which is bonded to a single organic moiety and carries two hydrogen atoms; a “secondary amine group” refers to an amine group which is bonded to two organic moieties which may also together be part of a ring and carries one hydrogen atom; a “tertiary amine group” refers to an amine group which is bonded to three organic moieties, two or three of which may also be part of one or more rings, and does not carry any hydrogen atoms.

The term “molecular weight” refers to the molar mass (g/mol) of a molecule. The term “average molecular weight” refers to the number average molecular weight (Mₙ) of an oligomeric or polymeric mixture of molecules. It is determined by means of gel permeation chromatography (GPC) against polystyrene as the standard, particularly with tetrahydrofuran as the mobile phase and a refractive index detector.

“Open time” is the time period, within an applied composition can be processed or reworked without any negative effect. It is exceeded when the viscosity of the composition due to progressing curing has risen too much, at latest when a skin is formed on the surface. The time period, until a skin is formed on the surface, is called “skin formation time” or “skinning time”.

“Room temperature” refers to a temperature of 23° C.

The term “weight-%” refers to the mass fraction of a constituent of a composition based on the entire composition, unless stated otherwise. The terms “weight” and “mass” are used synonymously in this document.

All industry standards and norms mentioned in this document refer to the versions valid at the time of filing the first application, if not specified.

The polymer P1 is preferably liquid at room temperature.

Preferably, the polymer P1 has a poly(oxyalkylene) backbone, particularly a poly(oxy-1,4-butylene) or poly(oxy-1,2-butylene) or poly(oxy-1,3-propylene) or poly(oxy-1,2-propylene) or poly(oxyethylene) backbone, or a mixture thereof.

Particularly the polymer P1 has a poly(oxy-1,2-propylene) backbone or a mixed 5 poly(oxyethylene) and poly(oxy-1,2-propylene) backbone.

Most preferably, the polymer P1 has a poly(oxy-1,2-propylene) backbone.

Preferably, the polymer P1 has an average molecular weight Mₙ of 4,000 to 30,000 g/mol, more preferably 6,000 to 25,000 g/mol, particularly 10,000 to 20,000 g/mol.

Preferably, the polymer P1 has an average silane functionality of 1.5 to 3, more preferably 1.6 to 2.3, particularly 1.8 to 2.

Preferably, the polymer P1 is free of hydroxyl groups and free of isocyanate groups.

Particularly preferred, the polymer P1 has a poly(oxyalkylene) backbone, an average molecular weight Mₙ of 6,000 to 25,000 g/mol and an average silane functionality of 1.8 to 2.

Such a polymer enables compositions with good application properties and cured materials of high flexibility.

In the silane groups of the formula (I), preferably n is 3.

Preferably, R¹ is methyl or ethyl or isopropyl, particularly methyl or ethyl.

Particularly preferred, n is 2 and R¹ is methyl, or n is 3 and R¹ is methyl or ethyl. Such a composition cures rapidly and enables a high mechanical strength.

With n=3 and R¹=methyl, the curing is particularly rapid.

With R¹=ethyl, the composition has toxicological benefits.

Preferably, R² is 1,3-propylene, 1,4-butylene, a methyl-substituted 1,4-butylene, a dimethyl-substituted 1,4-butylene, or a C₆ to C₁₂ hydrocarbon group containing an amide or a carbamate group, particularly a group of the formula

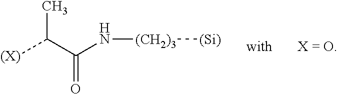

Preferably X is O or NR³.

Preferably, R³ is hydrogen, n-butyl, phenyl or a succinate-2-yl, Particularly preferred, R³ is diethyl succinate-2-yl.

Particularly preferred, R² is a C₃ to C₆ alkylene group, preferably 1,3-propylene, X is NR³ and R³ is a succinate-2-yl, preferably diethyl succinate-2-yl. Such a polymer P1 enables compositions of high elongation and flexibility together with good tear strength properties.

Preferably, D is a divalent C₆ to C₁₃ hydrocarbon group.

Particularly, D is selected from the group consisting of the divalent groups obtained after removing the two isocyanate groups of 1,6-hexane diisocyanate (HDI), isophorone diisocyanate (IPDI), 4,4′-diisocyanatodicyclohexylmethane (H₁₂MDI), diphenylmethane diisocyanate (MDI) and toluene diisocyanate (TDI).

Most preferred, D is the divalent group obtained after the removal of the two isocyanate groups from isophorone diisocyanate. Such a polymer P1 enables compositions with particularly good application properties and a high light fastness.

Most preferred is a polymer P1 containing silane groups of the formula (I) wherein n is 3, R¹ is methyl, R² is 1,3-propylene, X is NR³, R³ is diethyl succinate-2-yl and D is the divalent group obtained after the removal of the two isocyanate groups from isophorone diisocyanate.

A suitable polymer P1 is preferably obtained by the reaction of an isocyanate-functional polymer with at least one silane of the formula (II),

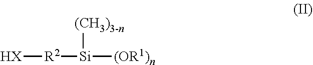

wherein n, R¹, R² and X have the already mentioned meanings.

Preferably, the reaction is conducted with exclusion of moisture at a temperature in the range of 20 to 140° C. in a molar ratio of the silane of the formula (II) and the isocyanate groups of 1/1 to 1.5/1, particularly 1/1 to 1.2/1.

Preferably, the isocyanate-functional polymer has a content of isocyanate groups of 0.4 to 3.5 weight-%, preferably 0.6 to 1.5 weight-%.

A suitable isocyanate-functional polymer is in turn particularly obtained from the reaction of at least one polyol and at least one diisocyanate of the formula OCN-D-NCO, wherein D has the already mentioned meanings.

The reaction is preferably conducted with exclusion of moisture at a temperature in the range of 20 to 160° C., especially 40 to 140° C., optionally in the presence of suitable catalysts. The molar NCO/OH ratio is preferably 1.3/1 to 2.5/1, particularly 1.8/1 to 2.1/1.

Suitable polyols for the preparation of the isocyanate-functional polymer are polyether polyols that are liquid at room temperature, particularly polyoxyalkylene diols and/or polyoxyalkylene triols, especially polymerization products of ethylene oxide or 1,2-propylene oxide or 1,2-butylene oxide or oxetane or tetrahydrofuran or mixtures thereof, where these may be polymerized with the aid of a starter molecule having two or three active hydrogen atoms, such as water, ammonia or a compound having multiple OH or NH groups, for example ethane-1,2-diol, propane-1,2-diol, propane-1,3-diol, neopentyl glycol, diethylene glycol, triethylene glycol, the isomeric dipropylene glycols or tripropylene glycols, the isomeric butanediols, pentanediols, hexanediols, heptanediols, octanediols, nonanediols, decanediols, undecanediols, cyclohexane-1,3- or -1,4-dimethanol, bisphenol-A, hydrogenated bisphenol-A, 1,1,1-trimethylolethane, 1,1,1-trimethylolpropane, glycerol or aniline, or mixtures of the aforementioned compounds.

Preferred are poly(oxy-1,2-propylene) diols or poly(oxy-1,2-propylene) triols, or so-called ethylene oxide-terminated (EO-capped) poly(oxy-1,2-propylene) diols or triols, which are obtained by further alkoxylating poly(oxy-1.2-propylene) diols or triols with ethylene oxide on conclusion of the polypropoxylation reaction, with the result that they have primary hydroxyl groups.

Preferred polyether polyols have a level of unsaturation of less than 0.02 meq/g, especially less than 0.01 meq/g.

Preferred are poly(oxy-1,2-propylene) diols or poly(oxy-1,2-propylene) triols optionally having terminal oxyethylene groups with an average OH functionality in the range of 1.6 to 3. Particularly preferred are poly(oxy-1,2-propylene) diols with an average OH functionality of 1.8 to 2.

Preferred are polyether polyols with an average molecular weight Mₙ in the range of 2,000 to 20,000 g/mol, preferably 4,000 to 18,000 g/mol, more preferably 8,000 to 15,000 g/mol.

Preferred are polyether polyols with an OH number in the range of 6 to 58 mg KOH/g, preferably 8 to 20 mg KOH/g.

Suitable diisocyanates of the formula OCN-D-NCO are 1,6-hexane diisocyanate (HDI), isophorone diisocyanate (IPDI), 4,4′-diisocyanatodicyclohexylmethane (H₁₂MDI), diphenylmethane diisocyanate (MDI) particularly 4,4′-diphenylmethane diisocyanate or its mixtures with 2,4′-diphenylmethane diisocyanate and 2,2′-diphenylmethane diisocyanate, and toluene diisocyanate (TDI) particularly 2,4-toluene diisocyanate or its mixtures with 2,6-toluene diisocyanate.

Particularly preferred is IPDI.

A suitable silane of the formula (II) is an aminosilane, particularly 3-aminopropyl-trimethoxysilane, 3-aminopropyldimethoxymethylsilane, 4-aminobutyltrimethoxysilane, 4-amino-3-methylbutyltrimethoxysilane, 4-amino-3,3-dimethylbutyltrimethoxysilane, N-butyl-3-aminopropyltrimethoxysilane, N-phenyl-3-aminopropyltrimethoxysilane, adducts 30 of primary aminosilanes such as 3-aminopropyltrimethoxysilane or 3-aminopropyldimethoxymethylsilane with Michael-acceptors such as acrylonitrile, esters or amides of (meth)acrylic acid, diesters of maleinic acid or fumaric acid or citraconic acid or itaconid acid, particularly diethyl N-(3-trimethoxysilylpropyl)aminosuccinate or diethyl N-(3-dimethoxymethylsilylpropyl)aminosuccinate, as well as the corresponding aminosilanes with ethoxysilanegroups instead of methoxysilanegroups.

A further suitable silane of the formula (II) is a mercaptosilane, particularly 3-mer-captopropyltrimethoxysilan, 3-mercaptopropyltriethoxysilan or 3-mercaptopropyl-dimethoxymethylsilan.

A further suitable silane of the formula (II) is a hydroxysilane, particularly N-(3-triethoxysilylpropyl)-2-hydroxypropanamide, N-(3-trimethoxysilylpropyl)-2-hydroxy-propanamide, N-(3-triethoxysilylpropyl)-4-hydroxypentanamide, N-(3-triethoxysilyl-propyl)-4-hydroxyoctanamide, N-(3-triethoxysilylpropyl)-5-hydroxydecanamide or N-(3-triethoxysilylpropyl)-2-hydroxypropylcarbamat, particularly N-(3-triethoxysilylpropyl)-2-hydroxypropanamide.

Particularly preferred silanes of the formula (II) are aminosilanes. Most preferred is diethyl N-(3-trimethoxysilylpropyl)aminosuccinate or diethyl N-(3-triethoxysilylpro-pyl)aminosuccinate.

A suitable liquid epoxy resin comprises customary technical epoxy resins which are free-flowing at room temperature and have a glass transition temperature of below 25° C. They are typically obtained from the glycidylation of polyphenols, polyols or amines by reaction with epichlorohydrin.

Suitable liquid epoxy resins are particularly aromatic liquid epoxy resins, especially the glycidylation products of
bisphenol-A or bisphenol-F, where A stands for acetone and F for formaldehyde, which served as reactants for the preparation of these bisphenols. In the case of bisphenol F, positional isomers may also be present, especially derived from 2,4′- or 2,2′-hydroxyphenylmethane.
dihydroxybenzene derivatives such as resorcinol, hydroquinone or catechol;
further bisphenols or polyphenols such as bis(4-hydroxy-3-methylphenyl)methane, 2,2-bis(4-hydroxy-3-methylphenyl)propane (bisphenol-C), bis(3,5-dimethyl-4-hydroxyphenyl)methane, 2,2-bis(3,5-dimethyl-4-hydroxyphenyl)propane, 2,2-bis(3,5-dibromo-4-hydroxyphenyl)propane, 2,2-bis(4-hydroxy-3-tert-butylphenyl)propane, 2,2-bis(4-hydroxyphenyl)butane (bisphenol-B), 3,3-bis(4-hydroxyphenyl)pentane, 3,4-bis(4-hydroxyphenyl)hexane, 4,4-bis(4-hydroxyphenyl)heptane, 2,4-bis(4-hydroxyphenyl)-2-methylbutane, 2,4-bis(3,5-dimethyl-4-hydroxyphenyl)-2-methylbutane, 1,1-bis(4-hydroxyphenyl)cyclohexane (bisphenol-Z), 1,1-bis(4-hydroxyphenyl)-3,3,5-trimethylcyclohexane (bisphenol-TMC), 1,1-bis(4-hydroxyphenyl)-1-phenylethane, 1,4-bis[2-(4-hydroxyphenyl)-2-propyl]benzene (bisphenol-P), 1,3-bis[2-(4-hydroxyphenyl)-2-propyl]benzene (bisphenol-M), 4,4′-dihydroxydiphenyl (DOD), 4,4′-dihydroxybenzophenone, bis(2-hydroxynaphth-1-yl)methane, bis(4-hydroxynaphth-1-yl)methane, 1,5-dihydroxynaphthalene, tris(4-hydroxyphenyl)methane, 1,1,2,2-tetrakis(4-hydroxyphenyl)ethane, bis(4-hydroxyphenyl) ether or bis(4-hydroxyphenyl) sulfone;
condensation products of phenols with formaldehyde that are obtained under acidic conditions, such as phenol novolaks or cresol novolaks, also called bisphenol-F novolaks;
aromatic amines such as aniline, toluidine, 4-aminophenol, 4,4′-methylenedi-phenyldiamine, 4,4′-methylenediphenyldi(N-methyl)amine, 4,4′-[1,4-phenylenebis(1-methylethylidene)]bisaniline (bisaniline-P) or 4,4′-[1,3-phenylenebis(1-methylethylidene)]bisaniline (bisaniline-M).

Further suitable liquid epoxy resins are aliphatic or cycloaliphatic polyepoxides, particularly
glycidyl ethers of saturated or unsaturated, branched or unbranched, cyclic or open-chain di-, tri- or tetrafunctional C₂ to C₃₀ alcohols, especially ethylene glycol, propylene glycol, butylene glycol, hexanediol, octanediol, polypropylene glycols, dimethylolcyclohexane, neopentyl glycol, dibromoneopentyl glycol, castor oil, trimethylolpropane, trimethylolethane, pentaerythritol, sorbitol or glycerol, or alkoxylated glycerol or alkoxylated trimethylolpropane;
a hydrogenated bisphenol-A or bisphenol-F liquid resin, or a glycidylation product of hydrogenated bisphenol-A or bisphenol-F;
an N-glycidyl derivative of amides or heterocyclic nitrogen bases, such as triglycidyl cyanurate or triglycidyl isocyanurate, or reaction products of epichlorohydrin with hydantoin;
epoxy resins from the oxidation of olefins such as, in particular, vinylcyclohexene, dicyclopentadiene, cyclohexadiene, cyclododecadiene, cyclododecatriene, isoprene, 1,5-hexadiene, butadiene, polybutadiene or divinylbenzene.

A preferred liquid epoxy resin is an aromatic polyglycidyl ether, preferably selected from bisphenol-A diglycidylether, bisphenol-F diglycidylether and phenol-formaldehyde novolak glycidylethers with an average functionality of 2.3 to 4, preferably 2.5 to 3. Such liquid epoxy resins are highly hydrophobic and of a comparatively low viscosity. They are commercially available, for example from Olin, Huntsman or Momentive.

Particularly preferred is a bisphenol-A diglycidylether.

Further particularly preferred is a phenol-formaldehyde novolak glycidylether with an average functionality of 2.5 to 3, such as D.E.N.® 431 (from Olin). It enables a particularly good adhesion on plastic substrates.

Preferably, the liquid epoxy resin has an average epoxy equivalent weight of 156 to 200 g/eq.

Preferably, the amount of the liquid epoxy resin in the one-component moisture curing composition is 10 to 35 weight parts in relation to 100 weight parts of the polymer P1.

The one-component moisture curing composition further contains at least one polyketimine.

Suitable polyketimines are condensation products of primary polyamines and ketones. Preferably, the condensation takes place with at least one mol of the ketone per mol equivalent primary amine groups, at a temperature of 10 to 100° C., whereby the released water is removed, preferably either by direct distillation or with the aid of a solvent as entrainer, such as toluene or cyclohexane. Primary polyamines further containing secondary amine groups can be further reacted with monoepoxides, such as phenylglycidylether.

Preferred are aliphatic, cycloaliphatic or arylaliphatic amines with two or three primary amine groups, particularly 2,2-dimethylpropane-1,3-diamine, pentane-1,3-diamine (DAMP), pentane-1,5-diamine, 1,5-diamino-2-methylpentane (MPMD), 2-butyl-2-ethylpentane-1,5-diamine (C11 neodiamine), hexane-1,6-diamine, 2,5-dimethylhexane-1,6-diamine, 2,2(4),4-trimethylhexamethylenediamine (TMD), heptane-1,7-diamine, octane-1,8-diamine, nonane-1,9-diamine, decane-1,10-diamine, undecane-1,11-diamine, dodecane-1,12-diamine, diethylenetriamine (DETA), dipropylenetriamine (DPTA), 3-(2-aminoethyl)aminopropylamine, bis(hexamethylene)triamine (BHMT), N5-(3-aminopropyl)-2-methylpentane-1,5-diamine, N3-(3-aminopentyl)pentane-1.3-diamine, N5-(3-amino-1-ethylpropyl)-2-methylpentane-1,5-diamine, 1,2-diaminocyclohexane, 1,3-diaminocyclohexane, 1,4-diaminocyclohexane, 1,3-bis(aminomethyl)cyclohexane, 1,4-bis(aminomethyl)cyclohexane, isophoronediamine (IPDA), 2(4)-methyl-1,3-diaminocyclohexane, bis(4-aminocyclohexyl)methane, bis(4-amino-3-methylcyclohexyl)methane, bis(4-amino-3-ethylcyclohexyl)methane, bis(4-amino-3,5-dimethylcyclohexyl)methane, bis(4-amino-3-ethyl-5-methylcyclohexyl)methane, 2,5(2,6)-bis(aminomethyl)bicyclo[2.2.1]heptane (NBDA), 3(4),8(9)-bis(aminomethyl)tricyclo[5.2.1.0^{2,6}]decane, 1,4-diamino-2,2,6-trimethylcyclohexane (TMCDA), menthane-1,8-diamine, 1,3-bis(aminomethyl)benzene (MXDA), 1,4-bis(aminomethyl)benzene, 3,6-dioxaoctane-1,8-diamine, 4,7-dioxadecane-1,10-diamine, 4,7-dioxadecane-2,9-diamine, 4,9-dioxadodecane-1,12-diamine, 5,8-dioxadodecane-3,10-diamine, 4,7,10-trioxatridecane-1,13-diamine, 3,9-bis(3-aminopropyl)-2,4,8,10-tetraoxaspiro[5.5]undecane, polyoxypropylenediamines or -triamines with an average molecular weight Mₙ of 200 to 5′000 g/mol, preferably of 200 to 500 g/mol.

Preferred thereof are MPMD, C₁₁ neodiamine, hexane-1,6-diamine, TMD, DETA, DPTA, 3-(2-aminoethyl)aminopropylamine, 1,2-diaminocyclohexane, 1,3-bis(ami-nomethyl)cyclohexane, 1,4-bis(aminomethyl)cyclohexane, IPDA, 2(4)-methyl-1,3-diaminocyclohexane, bis(4-aminocyclohexyl)methane, NBDA, MXDA or polyoxy-propylenediamines or -triamines with an average molecular weight Mₙ of 200 to 500 g/mol.

Particularly preferred are DETA, 1,2-diaminocyclohexane, IPDA or polyoxypropy-lenediamines or -triamines with an average molecular weight Mₙ of 200 to 500 g/mol.

Suitable ketones are particularly ketones with 3 to 15 C-atoms, preferably acetone, methyl ethyl ketone, methyl propyl ketone, methyl isopropyl ketone, methyl isobutyl ketone, methyl pentyl ketone, methyl isopentyl ketone, methyl isoamyl ketone, diethyl ketone, dipropyl ketone, diisopropyl ketone, dibutyl ketone, diisobutyl ketone, cyclopentanone, cyclohexanone or acetophenone.

Preferred thereof are methyl isobutyl ketone or cyclohexanone.

A particularly preferred polyketimine is the condensation product of (a) DETA, 1,2-diaminocyclohexane, IPDA or a polyoxypropylenediamine or -triamine with an average molecular weight Mₙ of 200 to 500 g/mol, and (b) methyl isobutyl ketone or cyclohexanone, in a ratio of at least one mol of the ketone per mol equivalent of the primary amine groups, whereby the condensation product is optionally further reacted with a monoepoxid, preferably phenylglycidylether.

Particularly preferred is the bisketimine of DETA and methyl isobutyl ketone, which is perferably further reacted on the secondary amine group with phenylglycidylether. Further particularly preferred is the bisketimine of IPDA and methyl isobutyl ketone. Further particularly preferred is the bisketimine of 1,2-diaminocyclohexane and cyclohexanone.

Preferably, the amount of the polyketimine in the composition is such, that the number of thr ketimine groups in relation to the number of the epoxy groups in the composition is 0.5 to 1.5, preferably 0.8 to 1.2.

The one-component moisture curing composition further contains 2 to 15 weight parts of at least one epoxy silane per 100 weight parts of the polymer P1.

Preferred epoxy silanes are glycidoxysilanes.

Particularly preferred is 3-glycidoxypropyl trimethoxysilane or 3-glycidoxypropyl triethoxysilane. For a polymer P1 with methoxysilane groups, 3-glycidoxypropyl trimethoxysilane is preferred. For a polymer P1 with ethoxysilane groups, 3-glyci-doxypropyl triethoxysilane is preferred.

The amount of the epoxy silane in the composition is preferably 2 to 10 weight parts, particularly 3 to 8 weight parts, per 100 weight parts of the polymer P1.

The preferred epoxy silane enable a long open time and a particularly good adhesion on mortar or concrete after water immersion, as well as on plastic substrates such as PVC or ABS.

The one-component moisture curing composition may contain further ingredients.

Preferably, the one-component moisture curing composition contains at least one drying agent.

Suitable drying agents are particularly vinyltrimethoxysilane, vinyltriethoxysilane, tetraethoxysilane, methoxymethylsilanes, orthoformic esters, organosilanes having a functional group in a position to the silane group such as N-(methyldimethoxy-silylmethyl)-O-methylcarbamate or (methacryloyloxymethyl)silanes, as well as calcium oxide or molecular sieves.

Preferred is vinyltrimethoxysilane or vinyltriethoxysilane.

In a preferred embodiment of the invention, the one-component moisture curing composition contains at least one ketiminosilane. A preferred ketiminosilane is the condensation product of 3-aminopropyl trimethoxysilane or 3-aminopropyl tri-ethoxysilane with at least one ketone, preferably methyl isobutyl ketone or methyl isoamyl ketone. Such a ketiminosilane enables a particularly fast curing and a particularly good adhesion on plastic substrates such as ABS.

Preferably, the one-component moisture curing composition contains at least one accelerator.

Suitable accelerators are substances that accelerate the crosslinking of polymers containing silane groups. Particularly suitable are metal catalysts, preferably com-pounds of titanium, zirconium, aluminium or tin, particularly organotin compounds, organotitanates, organozirconates or organoaluminates. These metal catalysts preferably have alkoxy groups, aminoalkoxy groups, sulfonate groups, carboxylate groups, 1,3-diketonate groups, 1,3-ketoesterate groups, dialkyl phosphate groups or dialkyl pyrophosphate groups. Particularly suitable is dibutyltin dilaurate, dibutyltin diacetylacetonate, dibutyltin dineodecanoate or dioctyltin dilaurate.

Suitable further accelerators are substances that accelerate the reaction of epoxy groups with amine groups and/or substances that accelerate the hydrolysis of ketimine groups, particularly acids or compounds that are hydrolyzable to acids, especially organic carboxylic acids such as salicylic acid, organic sulfonic acids such as p-toluenesulfonic acid, sulfonic esters, phosphoric acid or nitrates, particularly calcium nitrate. Particularly suitable is salicylic acid.

Preferably, the one-component moisture curing composition contains at least one filler. Suitable fillers are particularly ground or precipitated calcium carbonates, optionally coated with fatty acids such as stearates, further barytes, quartz flours, quartz sands, dolomites, wollastonites, calcined kaolins, sheet silicates such as mica or talc, zeolites, aluminum hydroxides, magnesium hydroxides, silicas including finely divided silicas from pyrolysis processes, cements, gypsums, fly ashes, industrially produced carbon blacks, graphite, metal powders for example of aluminum, copper, iron, silver or steel, PVC powders or lightweight fillers such as hollow glass beads or gas-filled plastic spheres (microspheres), especially the types obtainable under the Expancel® brand name (from Akzo Nobel).

Preferred are calcium carbonates, calcined kaolins, finely divided silicas or industrially produced carbon blacks.

The one-component moisture curing composition contains 0 to 500 weight parts of fillers per 100 weight parts of the polymer P1.

Preferred is an amount of fillers of 50 to 500 weight parts, particularly 100 to 300 weight parts, in relation to 100 weight parts of the polymer P1

Preferably, the one-component moisture curing composition contains at least one plasticizer.

Suitable plasticizers are particularly carboxylic esters such as phthalates, particularly diisononyl phthalate (DINP), diisodecyl phthalate (DIDP) or di(2-propylheptyl) phthalate (DPHP), hydrogenated phthalates or cyclohexane-1,2-dicarboxylates, particularly hydrogenated diisononyl phthalate or diisononyl cyclohexane-1,2-dicarboxylate (DINCH), terephthalates, particularly bis(2-ethylhexyl) terephthalate (DOTP) or diisononyl terephthalate (DINT), hydrogenated terephthalates or cyclohexane-1,4-dicarboxylates, particularly hydrogenated bis(2-ethylhexyl) terephthalate or bis(2-ethylhexyl) cyclohexane-1,4-dicarboxylate, or hydrogenated diisononyl terephthalate or diisononyl cyclohexane-1,4-dicarboxylate, isophthalates, trimellitates, adipates, particularly dioctyl adipate, azelates, sebacates, citrates, benzoates, glycol ethers, glycol esters, particularly triethylene glycol bis(2-ethylhexanoate), plasticizers having polyether structure, particularly poly(oxypropylene) monols or poly(oxypropylene) diols or poly(oxypropylene) triols, or poly(oxypropylene) monols, diols or triols with blocked hydroxyl groups, particularly in the form of acetate groups, organic phosphoric or sulfonic esters, polybutenes, polyisobutenes or plasticizers derived from natural fats or oils, especially epoxidized soybean or linseed oil.

Preferably, the plasticizers are selected from the group consisting of DINP, DIDP, DPHP, DINCH, DOTP, DINT, bis(2-ethylhexyl) cyclohexane-1,4-dicarboxylate, diisononyl cyclohexane-1,4-dicarboxylate, dioctyl adipate, poly(oxypropylene) monols, poly(oxypropylene) diols, poly(oxypropylene) triols and poly(oxypropylene) monols, diols and triols with blocked hydroxyl groups in the form of acetate groups.

Preferably, the one-component moisture curing composition contains plasticizers in an amount of 10 to 500 weight parts, preferably 20 to 300 weight parts, in relation to 100 weight parts of the polymer P1.

In a preferred embodiment of the invention, the composition contains no or only a small amount of plasticizers, preferably 0 to 50 weight-parts of plasticizers in relation to 100 weight parts of the polymer P1, and additionally at least one ketiminosilane. Such a composition has particularly good adhesion properties to plastic substrates, particularly ABS or PVC.

The one-component moisture curing composition may contain further additives, particularly
solvents or diluents other than plasticizers, perferably in an amount of less than 5 weight-%, particularly less than 1 weight-%, in relation to the total composition, whereby the alcohol and the ketone, which are released upon hydrolyses of the silane groups and the ketimines, are not included;
inorganic or organic pigments, particularly titanium dioxide, chromium oxides or iron oxides;
dyes;
rheology modifiers, particularly thickeners, particularly sheet silicates such as bentonites, derivatives of castor oil, hydrogenated castor oil, polyamides, polyurethanes, urea compounds, polyvinylchlorides, fumed silicas, cellulose ethers or hydrophobically modified poly(oxyethylenes);
natural resins, fats or oils, such as rosin, shellac, linseed oil, castor oil or soybean oil;
nonreactive polymers, particularly homo- or copolymers of unsaturated monomers such as ethylene, propylene, butylene, isobutylene, isoprene, vinyl acetate or alkyl (meth)acrylates, particularly polyethylenes (PE), polypropylenes (PP), polyisobutylenes, ethylene/vinyl acetate copolymers (EVA) or atactic poly-α-olefins (APAO);
fibers, particularly glass fibers, carbon fibers, metal fibers, ceramic fibers, hemp fibres, cellulose fibres or polymer fibers such as polyamide fibers or polyethylene fibers;
nanofillers such as graphene or carbon nanotubes;
flame-retardant substances, particularly the aluminum hydroxide or magnesium hydroxide fillers already mentioned, and also especially organic phosphoric esters, such as, in particular, triethyl phosphate, tricresyl phosphate, triphenyl phosphate, diphenyl cresyl phosphate, isodecyl diphenyl phosphate, tris(1,3-dichloro-2-propyl) phosphate, tris(2-chloroethyl) phosphate, tris(2-ethylhexyl) phosphate, tris(chloroisopropyl) phosphate, tris(chloropropyl) phosphate, isopropylated triphenyl phosphate, mono-, bis- or tris(isopropylphenyl) phosphates of different degrees of isopropylation, resorcinol bis(diphenylphosphate), bisphenol-A bis(diphenylphosphate) or ammonium polyphosphates;
further additives such as emulsifiers, wetting agents, leveling agents, defoamers, deaerators or stabilizers against oxidation, heat, light or UV radiation, or biocides.

It may be advisable to dry certain constituents chemically or physically before mixing them into the composition.

The inventive composition is prepared by mixing all ingredients under exclusion of moisture to obtain a macroscopically homogeneous fluid or paste and stored in a moisture-tight container at ambient temperatures. A suitable moisture-tight container consists preferably of an optionally coated metal or plastic. It is preferably a bucket, a barrel, a hobbock, a pouch, a sausage, a cartridge, a can, a bottle or a tube. With suitable packaging and storage, the inventive composition shows a good shelf life stability.

The process of curing begins when the packaging is opened and the inventive composition is applied, thereby getting in contact with moisture, particularly atmospheric moisture. Upon curing, the silane groups undergo hydrolysis with release of an alcohol, such as methanol in the case of methoxysilane groups or ethanol in the case of ethoxysilane groups, forming silanol groups (Si—OH groups) and, through subsequent condensation reactions, siloxane groups (Si—O—Si groups). Further, the ketimine groups also undergo hydrolysis with release of the corresponding ketone and react with epoxy groups. As a result of these reactions, the composition cures to form an elastic material. The moisture for the curing of the composition preferably is atmospheric moisture penetrating into the composition from the environmental air via diffusion processes. Upon curing, first a thin skin of cured composition is formed at the surface of the applied composition, which continuously grows in thickness as the curing process proceeds, until all of the applied composition is cured. Additional moisture contributing to the curing process may come from the substrates, to which the composition is applied, and/or from a water-containing or water-releasing accelerator component, which is mixed into the composition before or during its application or is sprayed or brushed onto the surface of the applied composition.

The inventive composition is preferably applied at ambient conditions, preferably in a temperature range of 0 to 50° C., particularly 5 to 40° C.

The curing of the composition preferably also takes place at ambient conditions. It typically extends over a few days to weeks until it is largely at an end under the prevailing conditions. In certain cases, it may be advantageous to subject a partly cured composition to further curing at an elevated temperature, such as 50 to 130° C. or more.

Another subject of the invention is the cured composition obtained from the one-component moisture curing composition as described above after its contact with moisture.

The one-component moisture curing composition is preferably used as an elastic adhesive and/or sealant or as an elastic coating.

Particularly preferred is the use as an elastic adhesive and/or sealant, particularly in the construction or manufacturing industry or in vehicle construction, particularly for joint or cavity sealing, for example for high rise façades or ship decks, for the bonding of wall panels to façades or for module bonding, particularly for module bondings in vehicle construction or for the sealing of battery boxes of e-vehicles.

The one-component moisture curing composition may be formulated in such a way, that it has a pasty consistency with pseudoplastic properties. Such a composition is preferably applied from a cartridge, a barrel or a hobbock, for example in the form of a bead with a round or triangular cross-sectional area.

The one-component moisture curing composition may further be formulated in such a way, that it has a fluid consistency with self-leveling properties, optionally with a slight thixotropy. Such a composition can be applied by spraying or pouring onto a flat or slightly sloped surface or into a cavity. The composition can then be spread to a desired layer thickness with a suitable tool, such as a squeegee, a toothed trowel, a spatula, a roller, a brush or a draw down bar.

The inventive one-component moisture curing composition has beneficial properties. It has a good shelf life stability together with good application properties, particularly a low viscosity and a long open time. Upon contact with moisture, it cures quickly at ambient conditions to form a non-tacky, highly elastic material with high tensile strength, high tear strength and soft-elastic properties. The inventive composition shows a particularly good adhesion, also without pretreatment of the substrates, particularly on dry and on wet mortar or concrete, whereby the adhesion remains good after water immersion of the adhesive bond. Most surprising is the excellent resistance to heat of the cured material, even up to 2 hours at 200° C., and also long-term resistance up to four weeks at 90° C. or 24 hours at 180° C. This allows applications such as the bonding of wall panels on buildings, the sealing of battery boxes of e-vehicles or the use for adhesive bonds on vehicle parts which are going to be heated, for example to cure a heat-curing varnish or powder coating.

Preferably, the cured composition has a Shore A hardness according to DIN 53505 of less than 55 after 7 days curing at 23° C. and 50% relative humidity.

Preferably, the cured composition has an elongation at break of more than 150% after 7 days curing at 23° C. and 50% relative humidity, determined according to DIN EN 53504 at a crosshead speed of 200 mm/min.

Preferably, the cured composition has an e-modulus of less than 5 MPa between 0.5 to 5% elongation after 7 days curing at 23° C. and 50% relative humidity, determined according to DIN EN 53504 at a crosshead speed of 200 mm/min.

Preferably, the cured composition has a tear strength of more than 3 N/mm after 7 days curing at 23° C. and 50% relative humidity, determined according to DIN ISO 34 at a crosshead speed of 500 mm/min with angular specimens.

The low e-modulus and the low Shore A hardness together with the high elongation ensures the soft-elastic properties of the cured material, which allows some movements of an adhesive and/or sealing bond without the transmission of high forces to the substrates, whereas the high tear strength ensures a high durability of the bond. Another subject of the invention is a method to make an elastic adhesive or sealing bond, comprising the steps of
(i) applying the one-component moisture curing composition
   onto a first substrate and contacting the composition with a second substrate, or
   onto a first and onto a second substrate and join the two substrates, or
   between two substrates,
(ii) followed by curing the composition by contact with moisture.

The application of the one-component moisture curing composition is preferably done as already described.

The substrates, which are bonded by the inventive method, are preferably
concrete, lightweight concrete, mortar, cement, fiber cement, brick, adobe, tile, slate, gypsum, gypsum panels, or natural stone, such as granite or marble;
glass or glass ceramic;
repair or levelling compounds based on PCC (polymer modified cement) or ECC (epoxy modified cement);
metals and alloys, such as aluminium, copper, iron, steel, nonferrous metals, including surface-finished metals and alloys, such as galvanized metals or chrome-plated metals;
asphalt;
bituminous felt;
plastics, such as hard or soft PVC, polycarbonate, polystyrene, polyester, polyamide, PMMA, ABS, SAN, epoxide resins, phenolic resins, PUR, POM, TPO, PE, PP, EPM or EPDM, in untreated form or surface-treated by means of plasma, corona or flame;
fibre reinforced plastics such as carbon fibre reinforced plastics, glass fibre reinforced plastics, natural fibre reinforced plastics or sheet moulding compounds;
timber or plywood, paper, cardboard, wood materials bonded with organic resins, resin-textile composites or so-called polymer composites;
insulating foams, particularly out of EPS, XPS, PUR, PIR, rock wool, glass wool or foamed glass;
coated substrates, such as varnished tiles, painted concrete, coated metals or varnished metal sheets.

It is possible to bond two identical or two different substrates.

These substrates are optionally pre-treated before the application of the composition, particularly by a physical and/or chemical cleaning process or by the application of an activator or primer.

Preferably, the substrates are not pre-treated with an activator or primer, as the inventive composition shows excellent adhesion properties also without pretreatement. A porous substrate such as concrete or mortar may be bonded in a humid or wet state.

The inventive one-component moisture curing composition has a sufficient open time to allow precise positioning and large surface applications and a fast curing progress, whereby the composition soon becomes tack-free and shows a fast build-up of mechanical strength and elasticity.

As a result of the inventive method, an article is obtained, which is bonded and/or sealed by the inventive composition. This article is preferably a building or an infrastructure object, or a part of these, preferably a façade, a roof, a balcony, a terrace, a staircase, a floor or a bridge, or it is an industrial good or a consumer good, particularly a window, a pipe, a household machine, a car, a bus, a truck, a rail vehicle, a ship, an airplane or a helicopter, or a part of these, such as a battery box of an e-vehicle.

### EXAMPLES

The following examples illustrate the present invention without being limiting.

“Standard conditions” means a temperature of 23±1° C. and a relative atmospheric moisture of 50±5% and is abbreviated with “SC”.

“EEW” means “epoxy equivalent weight”.

Chemical substances not otherwise specified are from Sigma-Aldrich Chemie GmbH and were used as obtained.

Diethyl N-(3-trimethoxysilylpropyl)aminosuccinate was prepared by reacting maleic acid diethylester and 3-aminopropyl trimethoxysilane.

### Preparation of Silane-Functional Polymers:

### Polymer ST-1:

1000 g of poly(oxypropylene) glycol (Acclaim® 12200, from Covestro; OH-number 11 mg KOH/g) and 43.6 g isophoronediisocyanate (Vestanat® IPDI, von Evonik) were reacted in the presence of dibutyltin dilaurate at 80° C. under exclusion of moisture to give an isocyanate-functional polymer with an NCO-content of 0.7 weight-% as determined by titration.

Then, 61.8 g of diethyl N-(3-trimethoxysilylpropyl)aminosuccinate were added and the polymer was kept at 80° C. under stirring until there were no isocyanate groups detectable my means of FT-IR spectroscopy. The obtained silane-functional polymer was then cooled to room temperature and kept under exclusion of moisture. It was clear and liquid at room temperature.

Preparation of polyketimines:

### Ketimine K1:

785.2 g (8 mol) cyclohexanone and 422.5 g (3.7 mol) 1,2-cyclohexanediamine (Dytek® DCH-99, from Invista) were mixed and reacted in a rotary evaporator under removal of the volatile contents at 80° C. and vacuum. The obtained bisketimine had an amine number of 452 mg KOH/g and a theoretical ketimine-equivalent weight of 137 g/eq.

### Ketimine K2:

90.1 g (0.9 mol) methyl isobutyl ketone and 51.1 g (0.3 mol) isophoronediamine (Vestamin® IPD, from Evonik) were mixed and reacted in a rotary evaporator under 25 removal of the volatile contents at 80° C. and vacuum. The obtained bisketimine had an amine number of 367 mg KOH/g and a theoretical ketimine equivalent weight of 165 g/eq.

### Ketimine K3:

360.6 g (3.6 mol) methyl isobutyl ketone and 137.0 g (1.2 mol) 1,2-cyclohexanediamine (Dytek® DCH-99, from Invista) were mixed and reacted in a rotary evaporator under removal of the volatile contents at 80° C. and vacuum. The obtained bisketimine had an amine number of 466 mg KOH/g and a theoretical ketimine equivalent weight of 139 g/eq.

### Ketimine K4:

647.8 g (6.6 mol) cyclohexanone and 510.9 g (3 mol) isophoronediamine (Vestamin® IPD, from Evonik) were mixed and reacted in a rotary evaporator under removal of the volatile contents at 80° C. and vacuum. The obtained bisketimine had an amine number of 351 mg KOH/g and a theoretical ketimine equivalent weight of 167 g/eq.

### Ketimine K5:

103.1 g (1.05 mol) cyclohexanone and 153.0 g (0.50 mol) α,ω-poly(oxypropylene) diamine with an average molecular weight Mₙ of 306 g/mol (mixture of 84.1 g Jeff-10 amine® D-230 and 68.9 g Jeffamine® D-400, from Huntsman) were mixed and reacted in a rotary evaporator under removal of the volatile contents at 80° C. and vacuum. The obtained bisketimine had an amine number of 253 mg KOH/g and a theoretical ketimine equivalent weight of 221.7 g/eq.

### One-Component Moisture Curing Compositions:

### Composition C1 to C6:

For each composition, the ingredients specified in Table 1 were mixed in the specified amounts (in parts by weight) under exclusion of moisture in a sealed polypropylene beaker by means of a centrifugal mixer (SpeedMixer™ DAC 150, FlackTek Inc.) until a homogeneous mixture was obtained, which was then stored in a moisture-tight container.

Each composition was tested as follows:

The adhesion was tested by applying two beads of 10×150 mm with a thickness of 5 mm on each substrate as given in table 1 without pretreatment except from cleaning the nonporous substrates with isoproanol or removing dust from the porous substrates, and left to cure at standard conditions for 7 days. Then, the adhesion of the first bead was tested by cutting the first few millimeters of the bead off the substrate, then holding the loose end of the bead with pliers and trying to pull the cured bead in vertical direction off the substrate (first number). After that, the specimen with the remaining bead was immersed in water at room temperature for 7 days, then dried with a cloth and the adhesion test was repeated with the remaining bead (second number). This means, the first number indicates the adhesion after 7 days at standard conditions, and the second number indicates the adhesion after additional 7 days of water immersion. The adhesion was judged with the following scale:
1=very good adhesion (>95% cohesive failure)
2=good adhesion (>70 to 95% cohesive failure)
3=some adhesion (>50 to 70% cohesive failure)
4=insufficient adhesion (>5 to 50% cohesive failure)
5=no adhesion (0 to 5% cohesive failure, i.e. >95% adhesive failure).

The cure speed was tested by applying a layer of 10 mm of the composition at standard conditions and determination of the thickness of the cured skin after 1 day and after 3 days (“Id SC”) (“3d SC”).

The Shore A hardness was determined according to DIN 53505 on test specimens cured for 7 days at standard conditions.

The max. tensile strength, the elongation at break and the strength at 50%, 100% and 150% elongation (el.) were determined according to DIN EN 53504 at a crosshead speed of 200 mm/min on flat dumbbell shaped specimens with a length of 75 mm at a gage length of 30 mm and a gage width of 4 mm, which were prepared by punching from a film with a thickness of 2 mm of the composition cured for 7 days at standard conditions.

The tear strength was determined according to DIN ISO 34 at a crosshead speed of 500 mm/min with angular specimens which were prepared by punching from the film as described for the determination of the tensile strength.

As a measure for heat stability, the determination the tensile strength and the strength at 150% elongation were repeated with test specimens, which were stored in an oven at 90° C. for the given time, followed by storage at standard conditions for additional 24 hours. A significant loss of strength indicates a poor heat stability.

The results are given in the Tables 1 and 2.

Reference examples are marked with “(Ref.)”.

TABLE 1
Composition (in weight parts) and adhesion
results of the Compositions C1 to C6.

| | | | | C4 | C5 | C6 |
|---|---|---|---|---|---|---|
| Composition | C1 | C2 | C3 | (Ref.) | (Ref.) | (Ref.) |
| Polymer ST-1 ¹ | 100 | 100 | 100 | 100 | 100 | — |
| MS Polymer ® ² | — | — | — | — | — | 100 |
| epoxy resin ³ | 24 | 17 | 12 | 24 | — | 24 |
| polyketimine ⁴ | 13 | 9 | 7 | 13 | — | 13 |
| epoxy silane ⁵ | 4 | 2 | 4 | — | — | 4 |
| vinyl silane ⁶ | 5 | 4 | 5 | 5 | 5 | 5 |
| calciumcarbonate ⁷ | 93 | 64 | 93 | 93 | 93 | 93 |
| calciumcarbonate ⁸ | 136 | 94 | 136 | 136 | 136 | 136 |
| plasticizer ⁹ | 207 | 112 | 225 | 210 | 244 | 207 |
| dibutyltin dilaurate | 1 | 1 | 1 | 1 | 1 | 1 |
| adhesion on: | | | | | | |
| galvanized steel ¹⁰ | 1/1 | 1/1 | 1/1 | 1/1 | 1/1 | 1/1 |
| stainless steel SUS304 ¹¹ | 1/1 | 1/1 | 1/1 | 1/1 | 1/1 | 1/1 |
| aluminium ¹⁰ | 1/1 | 1/1 | 1/1 | 1/1 | 1/1 | 1/1 |
| mortar ¹⁰ | 1/1 | 1/1 | 1/1 | 1/1 | 1/4 | 1/4 |
| concrete ¹² | 1/1 | 1/1 | 1/1 | 1/3 | 1/4 | 3/1 |

¹ prepared as described above
² poly(oxypropylene) polymer with dimethoxymethylsilane end groups from a hydrosilylation process (MS Polymer S303H, from Kaneka)
³ bisphenol-A diglycidylether with EEW 187 g/eq (jER ® 828, from Mitsubishi Chemical)
⁴ bisketimine from diethylene triamine and methyl isobutyl ketone, adduct with phenylglycidylether (Daitocurar ® E-5493, from Daito Sangyo)
⁵ 3-glycidoxypropyl trimethoxysilane (KBM-403, from Shin-Etsu)
⁶ vinyltrimethoxysilane (KBM-1003, from Shin-Etsu)
⁷ precipitated and stearate coated
⁸ ground
⁹ diisodecyl phthalate (Palatinol ® 10-P, from BASF)
¹⁰ galvanized steel, aluminium A5052P or JIS mortar, purchased from TP-giken, Japan
¹¹ SUS 304 JIS G, 4305, purchased from Testpiece, Japan
¹² produced by Sika Japan

TABLE 2
Further properties of the Compositions C1 to C5.

| | | | | | C4 | C5 |
|---|---|---|---|---|---|---|
| Composition | | C1 | C2 | C3 | (Ref.) | (Ref.) |
| cure | 1 d SC | 2.6 | 3.0 | 2.8 | 2.9 | no cure |
| speed | 3 d SC | 4.6 | 5.1 | 4.9 | 5.2 | 4.5 |
| [mm] | | | | | | |
| Shore A | | 32 | 40 | 24 | 25 | 9 |
| max. tensile strength [MPa] | | 1.0 | 1.4 | 0.8 | 0.9 | 0.6 |
| elongation at break [%] | | 270 | 300 | 330 | 490 | 900 |
| strength at 50% el. [MPa] | | 0.55 | 0.77 | 0.44 | 0.44 | 0.22 |
| strength at 100% el. [MPa] | | 0.66 | 0.79 | 0.48 | 0.50 | 0.23 |
| strength at 150% el. [MPa] | | 0.82 | 1.05 | 0.64 | 0.63 | 0.26 |
| tear strength [N/mm] | | 4.0 | 5.4 | 3.4 | 5.2 | 3.0 |
| heat stability at 90° C.: | | | | | | |
| strength at 150% el. | | | | | | |
| [MPa] | after 14 d 90° C. | 0.98 | 1.19 | 0.69 | 0.69 | <0.1 fluid |
| | after 28 d 90° C. | 0.97 | 1.15 | 0.68 | 0.68 | |
| max. tensile strength | | | | | | |
| [MPa] | after 14 d 90° C. | 1.1 | 1.5 | 0.9 | 0.85 | <0.1 fluid |
| | after 28 d 90° C. | 1.1 | 1.4 | 0.8 | 0.8 | |

The Tables 1 and 2 show, that the reference Composition C4 without epoxy silane shows an insufficient adhesion on concrete after water immersion, and the reference Composition C5 without epoxy resin and polyketimine shows an insufficient adhesion on mortar and on concrete after water immersion, an insufficient cure speed after the first day of application and an insufficient heat stability, whereas the reference composition C6 with MS Polymer instead of Polymer ST-1 showed an insufficient adhesion on mortar and on concrete after water immersion.

### Composition C7 to C16:

For each composition, the ingredients specified in Table 3 or 5 were mixed in the specified amounts (in parts by weight) under exclusion of moisture in a sealed polypropylene beaker by means of a centrifugal mixer (SpeedMixer™ DAC 150, FlackTek Inc.) until a homogeneous mixture was obtained, which was then stored in a moisture-tight container.

The compositions were tested as follows:

The adhesion was tested on AIMg3 (aluminum with low content of silicone, from Rocholl in Germany), on AIMgSi1 (aluminum with high content of silicone, also from Rocholl), on ABS (acrylnitrile-butadien-styrene polymer, from Rocholl), on FRP (fiberglass reinforced plastic, POLYDET® performance Plus-WR, from Optiplan in Germany), on PVC (hard PVC, from Rocholl) and on concrete, each without any pretreatment except from cleaning the nonporous substrates with isopropanol or removing dust from the concrete. For each adhesion test, four beads were applied and left to cure for 7 days at standard conditions. Then, a first adhesion test was made with the first bead (first number). After that, the specimen with the remaining beads was immersed in water at room temperature for 7 days, dried with a cloth and a next bead was tested for adhesion (second number). After that, the specimen with the remaining beads was stored in an oven at 80° C. for 24 h, left to cool at room temperature and a next bead was tested for adhesion (third number). After that, the specimen with the remaining bead was stored at 70° C. and 100% relative humidity for 7 days, left to cool at room temperature and the last bead was tested for adhesion (fourth number). This means, the first number indicates the adhesion after 7 days at standard conditions, the second number indicates the adhesion after additional 7 days of water immersion, the third number indicates the adhesion after additional 24 h at 80° C. and the fourth number indicates the adhesion after additional 7 days at 70° C./100% rh. The beads were tested and the adhesion was judged as described for the Composition C1. For the adhesion on concrete, the testing was stopped after the third test (24 h at 80° C.).

The skinning time (skin formation time) was determined at standard conditions by applying a few grams of the composition in a layer thickness of approx. 2 mm on cardboard and gently touching its surface with an LDPE pipette from time to time, until the touching did not leave any residues on the pipette.

Tensile strength, elongation, tear strength and Shore A hardness were determined as described for the Composition C₁.

The e-modulus 5% was calculated from the test for tensile strength in the range of 0.5 to 5% elongation,

As a measure for the heat stability, the determination of Shore A hardness was repeated with test specimens, which were additionally stored in an oven at 180° C. or 200° C. for the given time, followed by storage at standard conditions for additional 24 hours. A significant loss of hardness indicates a poor heat stability.

The results are given in the Tables 3 to 6.

Reference examples are marked with “(Ref.)”.

TABLE 3
Composition (in weight parts) and adhesion
results of the Compositions C7 to C12.

| | | | | C10 | C11 | C12 |
|---|---|---|---|---|---|---|
| Composition | C7 | C8 | C9 | (Ref.) | (Ref.) | (Ref.) |
| Polymer ST-1 ¹ | 100.0 | 100.0 | 100.0 | 100.0 | 100.0 | 100.0 |
| epoxy resin ² | 15.6 | 26.0 | 15.6 | 15.6 | 15.6 | — |
| Ketimine K1 ¹ | 6.3 | 10.4 | 6.3 | 6.3 | 6.3 | — |
| epoxy silane ³ | 6.3 | 6.3 | 6.3 | — | — | 6.3 |
| ketiminosilane ⁴ | 3.1 | 3.1 | — | 3.1 | — | — |
| aminosilane ⁵ | — | — | — | — | — | 3.1 |
| vinyl silane ⁶ | 6.3 | 6.3 | 6.3 | 6.3 | 6.3 | 6.3 |
| calcium carbonate⁷ | 125.9 | 125.9 | 125.9 | 125.9 | 125.9 | 125.9 |
| titanium dioxide ⁸ | 12.5 | 12.5 | 12.5 | 12.5 | 12.5 | 12.5 |
| plasticizer ⁹ | 32.4 | 32.4 | 32.4 | 32.4 | 32.4 | 32.4 |
| stabilizer | 0.6 | 0.6 | 0.6 | 0.6 | 0.6 | 0.6 |
| catalyst ¹⁰ | 3.1 | 3.1 | 3.1 | 3.1 | 3.1 | 3.1 |
| dibutyltin dilaurate | 0.4 | 0.4 | 0.4 | 0.4 | 0.4 | 0.4 |
| adhesion on: | | | | | | |
| AlMg3 | 1 1 1 1 | 1 1 1 1 | 1 1 1 1 | 1 1 1 1 | 2 1 1 1 | 1 1 1 1 |
| AlMgSi1 | 1 1 1 1 | 1 1 1 1 | 1 1 1 1 | 1 1 1 1 | 2 1 1 1 | 1 1 1 1 |
| ABS | 1 2 1 1 | 1 1 1 2 | 2 3 2 2 | 3 3 3 3 | 3 3 3 4 | 4 4 3 4 |
| FRP | 1 1 1 1 | 1 1 1 1 | 1 1 1 1 | 1 1 1 1 | 1 1 1 1 | 1 1 1 1 |
| PVC | 1 1 1 1 | 1 1 1 1 | 1 1 1 1 | 3 1 1 1 | 4 3 1 1 | 3 3 1 1 |
| concrete | 1 2 2 | 1 2 2 | 2 3 1 | 1 4 1 | 1 4 1 | 2 4 1 |

¹ prepared as described above
² phenol-formaldehyde novolak glycidyl ether with EEW 175 g/eq (D.E.N. ® 431, from Olin).
³ 3-glycidoxypropyl trimethoxysilane (Silquest ® A-187, from Momentive)
⁴ KBE-9013P (from Shin-Etsu)
⁵ 3-aminopropyl trimethoxysilane (Silquest ® A-1110, from Momentive)
⁶ vinyltrimethoxysilane (Silquest ® A-171, from Momentive)
⁷Omyacarb ® 5-GU (from Omya)
⁸ Kronos ® 2220 (from Kronos)
⁹ poly(oxypropylene) glycol (Acclaim ® 4200, from Covestro)
¹⁰ salicylic acid 5 weight-% in dioctyl adipate

TABLE 4
Further properties of the Compositions C7 to C12.

| | | | | C10 | C11 | C12 |
|---|---|---|---|---|---|---|
| Composition | C7 | C8 | C9 | (Ref.) | (Ref.) | (Ref.) |
| skinning time [min] | 102 | 135 | 160 | 50 | 75 | 35 |
| max. tensile strength | 1.6 | 2.0 | 1.7 | 1.8 | 2.1 | 1.3 |
| [MPa] | | | | | | |
| elongation at break | 196 | 184 | 237 | 284 | 358 | 172 |
| [%] | | | | | | |
| e-modulus 5% [MPa] | 2.4 | 3.4 | 2.2 | 1.9 | 1.2 | 2.2 |
| tear strength [N/mm] | 3.5 | 4.3 | 3.7 | 4.1 | 4.4 | 2.6 |
| Shore A | 42 | 47 | 42 | 38 | 32 | 45 |
| heat stability: | | | | | | |
| Shore A after | | | | | | |
| 3 h 180° C. | 51 | 61 | 43 | 37 | 13 | 34 |
| 24 h 180° C. | 55 | 66 | 44 | 36 | <2 | <2 |
| 1 h 200° C. | 49 | 58 | 41 | 39 | 18 | 36 |
| 2 h 200° C. | 47 | 57 | 38 | 30 | 2 | 20 |

TABLE 5
Composition (in weight parts) and adhesion results
of the Compositions C7 and C13 to C16.

| Composition | C7 | C13 | C14 | C15 | C16 |
|---|---|---|---|---|---|
| Polymer ST-1 ¹ | 100.0 | 100.0 | 100.0 | 100.0 | 100.0 |
| epoxy resin ² | 15.6 | 15.6 | 15.6 | 15.6 | 15.6 |
| Ketimine ¹ | K-1 | K-2 | K-3 | K-4 | K-5 |
| | 6.3 | 7.5 | 6.3 | 7.5 | 11.3 |
| epoxy silane ² | 6.3 | 6.3 | 6.3 | 6.3 | 6.3 |
| ketiminosilane ² | 3.1 | 3.1 | 3.1 | 3.1 | 3.1 |
| vinyl silane ² | 6.3 | 6.3 | 6.3 | 6.3 | 6.3 |
| calcium carbonate ² | 125.9 | 125.9 | 125.9 | 125.9 | 125.9 |
| titanium dioxide ² | 12.5 | 12.5 | 12.5 | 12.5 | 12.5 |
| plasticizer ² | 32.4 | 32.4 | 32.4 | 32.4 | 27.4 |
| stabilizer | 0.6 | 0.6 | 0.6 | 0.6 | 0.6 |
| catalyst ² | 3.1 | 3.1 | 3.1 | 3.1 | 3.1 |
| dibutyltin dilaurate | 0.4 | 0.4 | 0.4 | 0.4 | 0.4 |
| adhesion on: | | | | | |
| AlMg3 | 1111 | 1111 | 1111 | 1111 | 1111 |
| AlMgSi1 | 1111 | 1111 | 1111 | 1111 | 1111 |
| ABS | 1211 | 1211 | 1443 | 1211 | 3311 |
| FRP | 1111 | 1111 | 1111 | 1111 | 1111 |
| PVC | 1111 | 1111 | 1111 | 1111 | 1111 |
| concrete | 122 | 122 | 132 | 231 | 231 |

¹ prepared as described above
² same as in Table 3

TABLE 6
Further properties of the Compositions C7 and C13 to C16.

| Composition | C7 | C13 | C14 | C15 | C16 |
|---|---|---|---|---|---|
| skinning time [min] | 102 | 157 | 103 | 109 | 120 |
| max. tensile strength | 1.6 | 2.1 | 1.8 | 2.1 | 2.0 |
| [MPa] | | | | | |
| elongation at break [%] | 196 | 188 | 199 | 177 | 167 |
| e-modulus 5% [MPa] | 2.4 | 3.1 | 2.6 | 3.0 | 3.2 |
| tear strength [N/mm] | 3.5 | 4.1 | 3.7 | 4.0 | 3.8 |
| Shore A | 42 | 51 | 46 | 48 | 50 |
| heat stability: | | | | | |
| Shore A after | | | | | |
| 3 h 180° C. | 51 | 47 | 51 | 52 | 52 |
| 24 h 180° C. | 55 | 62 | 52 | 66 | 62 |
| 1 h 200° C. | 49 | 45 | 51 | 51 | 45 |
| 2 h 200° C. | 47 | 50 | 45 | 49 | 50 |

1. One-component moisture curing composition comprising
100 weight parts of a polymer containing silane groups of the formula (I), 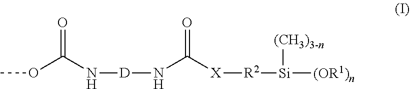
wherein
n is 2 or 3
R¹ is a linear or branched C₁ to C₅ alkyl group,
R² is a difunctional C₂ to C₁₂ hydrocarbon group or a difunctional C₃ to C₁₂ hydrocarbon group containing an amide or a carbamate group,
X is O or S or NR³, and R³ is hydrogen or a C₁ to C₁₀ hydrocarbon group or a C₃ to C₂₀ hydrocarbon group containing one or two ether or carboxylic ester groups or an alkoxysilane group, and
D is a divalent C₄ to C₁₅ hydrocarbon group,
5 to 50 weight parts of at least one liquid epoxy resin,
at least one polyketimine,
2 to 15 weight parts of at least one epoxy silane,
0 to 500 weight parts of fillers, and
0 to 500 weight parts of plasticizers.

2. The composition according to claim 1, wherein the polymer has a poly(oxyalkylene) backbone, an average molecular weight Mₙ of 6,000 to 25,000 g/mol and an average silane functionality of 1.8 to 2.

3. The composition according to claim 1, wherein n is 2 and R¹ is methyl or n is 3 and R¹ is methyl or ethyl.

4. The composition according to claim 1, wherein R² is a C₃ to C₆ alkylene group X is NR³ and R³ is a succinate-2-yl.

5. The composition according to claim 1, wherein D is selected from the group consisting of the divalent groups obtained after removing the two isocyanate groups of 1,6-hexane diisocyanate, isophorone diisocyanate, 4,4′-diisocyanatodicyclohexylmethane, diphenylmethane diisocyanate and toluene diisocyanate.

6. The composition according to claim 1, wherein the liquid epoxy resin is an aromatic polyglycidyl ether; with an average functionality of 2.3 to 4.

7. The composition according to claim 1, wherein the amount of liquid epoxy resin is 10 to 35 weight parts in relation to 100 weight parts of the polymer.

8. The composition according to claim 1, wherein the polyketimine is the condensation product of diethylenetriamine, 1,2-diaminocyclohexane, isophoronediamine or a polyoxypropylenediamine or -triamine with an average molecular weight Mₙ of 200 to 500 g/mol, and methyl isobutyl ketone or cyclohexanone, in a ratio of at least one mol of the ketone per mol equivalent of the primary amine groups, whereby the condensation product is optionally further reacted with a monoepoxid, preferably phenylglycidylether.

9. The composition according to claim 1, wherein the amount of the polyketimine in the composition is such, that the number of the ketimine groups in relation to the number of the epoxy groups in the composition is 0.5 to 1.5.

10. The composition according to claim 1, wherein the amount of fillers is 50 to 500 weight parts in relation to 100 weight parts of the polymer.

11. The composition according to claim 1, wherein the plasticizers are selected from the group consisting of diisononyl phthalate, diisodecyl phthalate, di(2-propylheptyl) phthalate, diisononyl cyclohexane-1,2-dicarboxylate, bis(2-ethylhexyl) terephthalate, diisononyl terephthalate, bis(2-ethylhexyl) cyclohexane-1,4-dicarboxylate, diisononyl cyclohexane-1,4-dicarboxylate, dioctyl adipate, poly(oxypropylene) monols, poly(oxypropylene) diols, poly(oxypropylene) triols and poly(oxypropylene) monols, diols and triols with blocked hydroxyl groups in the form of acetate groups.

12. The composition according to claim 1, wherein the amount of plasticizers is 10 to 500 weight parts; in relation to 100 weight parts of the polymer.

13. The composition according to claim 1, wherein the amount of plasticizers is 0 to 50 weight parts in relation to 100 weight parts of the polymer and the composition additionally contains at least one ketiminosilane.

14. A cured composition obtained from the composition according to claim 1 after its contact with moisture.

15. A method to make an elastic adhesive or sealing bond, comprising the steps of
(i) applying the composition according to claim 1
onto a first substrate and contacting the composition with a second substrate, or
onto a first and onto a second substrate and join the two substrates, or
between two substrates,
(ii) followed by curing the composition by contact with moisture.
